(19) United States
(12) Patent Application Publication
(10) Pub. No.: US 2012/0255833 A1
(43) Pub. Date: Oct. 11, 2012

(54) PALLET TRANSFERRING APPARATUS OF HORIZONTAL TYPE MACHINE TOOL

(75) Inventor: Gn Woo Ryu, Changwon-si (KR)

(73) Assignee: DOOSAN INFRACORE CO., LTD., Incheon (KR)

(21) Appl. No.: 13/497,469

(22) PCT Filed: Sep. 20, 2010
(86) PCT No.: PCT/KR10/06494

§ 371 Date: Mar. 21, 2012

(30) Foreign Application Priority Data
Sep. 22, 2009 (KR) 10-2009-0089315

(51) Int. Cl. B65G 35/06

(52) U.S. Cl. 198/465.1

(57) ABSTRACT

A pallet transferring apparatus of a horizontal type machine tool according to the present invention includes: a carrier transferring a pallet and having cam guide surfaces on both sides; a servo motor; a decelerator decelerating rotational force received from the servo motor and increasing torque; a pinion converting the rotational force into linear reciprocation movement of the carrier when the pinion is installed on the side of the carrier and receives the rotational force; a rack engaging with the pinion and transferring the rotational force received from the decelerator to the pinion; and a cam follower engaging with the cam guide surface of the carrier to guide forward and backward reciprocation transferring of the carrier.

This Application is a Section 371 National Stage Application of International Application No. PCT/KR2010/006494, filed Sep. 20, 2010 and published, not in English, as WO2011/037402 on Mar. 31, 2011.

### FIELD OF THE DISCLOSURE

The present disclosure relates to a multi pallet station of a horizontal type machine tool, and more particularly, to an apparatus capable of achieving a cost saving effect while significantly improving operational reliability as a structure of supporting a linear shaft of a pallet transferring apparatus (carrier) adopted in the horizontal type machine tool.

### BACKGROUND OF THE DISCLOSURE

In recent years, in a horizontal type machine tool, a multi pallet station has been used to effectively receive a plurality of pallets and facilitate discharging of the plurality of pallets. In the multi pallet station, a pallet transferring apparatus for moving forward and backward the pallet loading a workpiece is required, and in the related art, a ball screw and an LM guide are used to move forward/backward the pallet and a hydraulic cylinder is used to move up and down the pallet.

As shown in FIGS. 1 and 2, in the pallet transferring apparatus in the related art, rotational force generated from a servo motor 2 is converted into linear reciprocation transferring movement by a ball screw 3 and a horizontal LM guide 4 guides linear reciprocation movement of the carrier 1 in order to move forward/backward the carrier 1. The reason for using the ball screw 3 in moving forward/backward the carrier 1 is to ensure positional precision for accurately seating a pallet P at an accurate position in an equipment.

Upward and downward movements of the carrier 1 are implemented by using a hydraulic cylinder 8 and a vertical LM guide 5. In the upward and downward movements, since only an interference of a full stud 6 for a guide pin (not shown) and a pallet clamp needs to be avoided, the hydraulic cylinder 8 is used.

In addition, a roll cover 9 is attached to the horizontal LM guide 4 for supporting forward/backward movements of the carrier 1 for protection from a chip and a coolant.

However, the pallet transferring apparatus in the related art has the following problems.

The carrier 1 is fixed to the ball screw 3 and the carrier 1 has the same shape regardless of the size and the type (ex.: 400-grade HMC equipment to 800-grade HMC equipment) of the equipment. Therefore, when the equipment is upsized, an allowable load and a size of the workpiece also increase. When the equipment is upsized, capacities of the LM guides 4 and 5, the ball screw 3, and the hydraulic cylinder 8, that support the load during forward and backward movements and upward and downward movements, increase, and as a result, a main structure becomes bigger again.

In other words, in the case of small-sized equipment in which the allowable load of the pallet is equal to or less than a predetermined level (ex.: 800 kg), a problem does not occur even with basic ball screw and LM guide structures, but in large-sized equipment in which the allowable load increases by 1.5 times (ex.: 1200 kg) and extra-large equipment larger therethan (ex.: 3000 kg), the ball screw and the LM guide which are basically set need to be used with being increased by several steps, and as a result, a sudden increase in terms of a prime cost and largeness on a structural side occur.

Further, due to largeness in the ball screw and LM guide structures, handling during assembly and adjustment is difficult and a lot of time is required, and even maintenance and repairing are not easy due to an increase in weight and volume of a unit component of the equipment after sales and delivery.

Moreover, since an installation space of the roll cover 9 for protecting the LM guide 4 is small, the roll cover 9 is primarily used due to the constraint, but when the roll cover 9 is exposed to cutting oil with high toxicity for a long time, the roll cover 9 cannot have its own shape like a case in which roll cover 9 is wrinkled and the entirety of the roll cover 9 should be replaced frequently due to a limit in durability of an internal spring of the roll cover 9 taking charge of tightening and releasing.

The discussion above is merely provided for general background information and is not intended to be used as an aid in determining the scope of the claimed subject matter.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure is contrived to solve the above-described problems in the related art and an object of the present disclosure is to provide a pallet transferring apparatus capable of minimizing a prime cost rise factor caused due to an increase in size of a pallet while maintaining positional precision of a ball screw and an LM guide which is a linear reciprocation moving means of a carrier of a pallet transferring apparatus for a horizontal type machine tool in the related art.

Further, another object of the present disclosure is to provide a pallet transferring apparatus capable of ensuring the same positional precision when a carrier performs linear reciprocation movement as a more simple structure than the ball screw and the LM guide in the related art.

In addition, yet another object of the present disclosure is to provide a cover means capable of increasing durability and apparatus reliability as compared with a roll cover in the related art.

In order to achieve the above object, a pallet (P) transferring apparatus of a horizontal type machine tool according to the present disclosure adopts pinion/rack and cam follower structures instead of a ball screw and an LM guide in the related art in order to horizontally and reciprocatively transfer a carrier.

In detail, the pallet (P) transferring apparatus of a horizontal type machine tool according to the present disclosure includes: a carrier 10 transferring a pallet P; a servo motor 20; a decelerator 30 decelerating rotational force received from the servo motor 20 and increasing torque; a pinion 40 converting the rotational force into linear reciprocation movement of the carrier 10 when the pinion 40 is installed on the side of the carrier 10 and receives the rotational force; a rack 50 engaging with the pinion 40 and transferring the rotational force received from the decelerator 30 to the pinion 40; and a cam follower 60 guiding forward and backward reciprocation transferring of the carrier 10.

Further, the pallet (P) transferring apparatus of a horizontal type machine tool according to the present disclosure may further include: a pivot means 70 rotatably fixing a rotational shaft B with respect to a fixation shaft A parallel to a horizontal plane; and a rotating means 80 varying an angle between the carrier 10 on the rotational shaft B and the horizontal plane by rotating the rotational shaft B around the center of the pivot means 70, preferably a hydraulic cylinder. Therefore, since the pallet (P) transferring apparatus may be configured by one fixation shaft and one rotational shaft, a pallet receiving structure is simplified as compared with the structure in the related art which receives the pallet along two vertical/horizontal fixation shafts.

In addition, the pallet (P) transferring apparatus of a horizontal type machine tool according to the present disclosure may further include a slide cover 90 for protecting the carrier 10 from impurities according to a linear reciprocation transferring position of the carrier 10.

Meanwhile, according to a preferred exemplary embodiment, the cam follower 60 may include: a first cam follower 61 which is eccentric to fix the top and the bottom of the carrier 10 simultaneously; and a second cam follower 62 for preventing horizontal swing of the carrier 10.

As described above, according to the present disclosure, a rack/pinion and a cam follower are adopted instead of a ball screw and an LM guide in the related art as a linear reciprocation transferring means of a carrier, such that the same precision is implemented without reducing positional precision which was an advantage of a structure in the related art while remarkably reducing an increase in cost due to an increase in size of an apparatus.

Further, according to the present disclosure, the rack/pinion and the cam follower are adopted and a pivot means is adopted instead of the ball screw and the LM guide in the related art, such that the number of constituent components decreases and the structure is simplified, thereby saving a prime cost and even contributing to shortening a working time when a service is generated.

In addition, according to the present disclosure, a multistep slide cover of which the length is extensible is adopted instead of the roll cover in the related art to be adaptable to a change in length depending on the linear reciprocation transferring of the carrier, even impurity preventing performance and durability are epochally improved as compared with the roll cover in the related art, and reliability of the entire equipment is improved.

### DESCRIPTION OF THE DRAWINGS

FIG. 1 is a perspective view showing a pallet transferring apparatus in the related art.

FIG. 2 is a detailed diagram showing a linear shaft supporting structure of the pallet transferring apparatus in the related art.

FIG. 3 is a perspective view of a pallet transferring apparatus according to the present disclosure.

FIGS. 4 and 5 are detailed diagrams showing a linear shaft supporting structure of the pallet transferring apparatus according to the present disclosure.

FIGS. 6 and 7 are side views showing the linear shaft supporting structure of the pallet transferring apparatus according to the present disclosure.

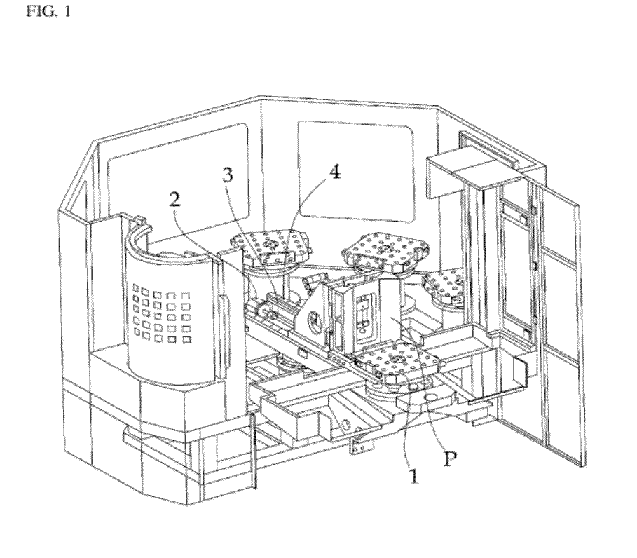

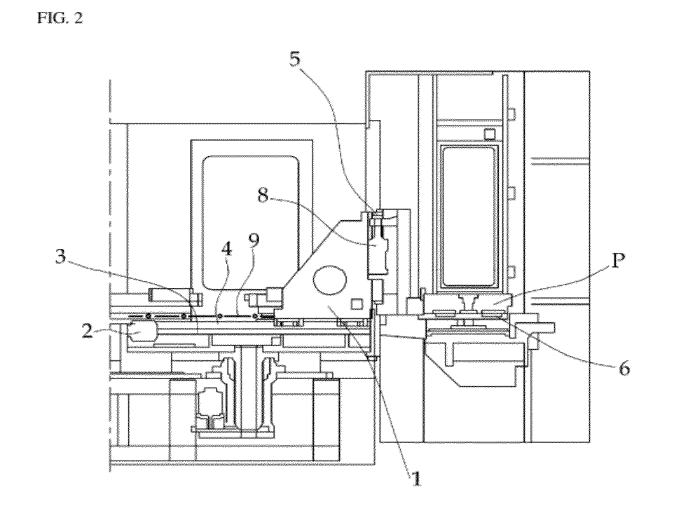

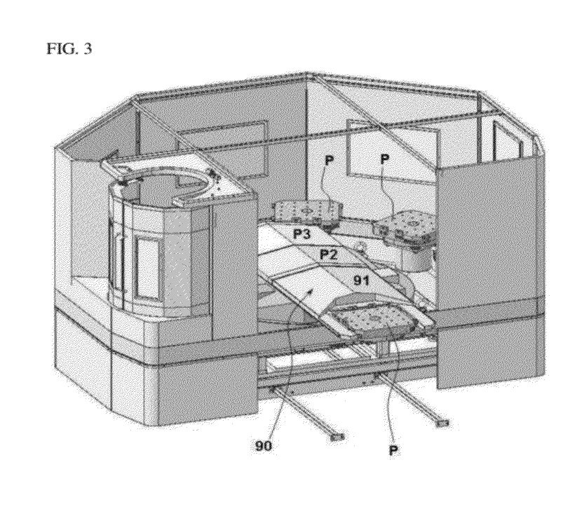

P: Pallet
1: Carrier
2: Servo motor
3: Ball screw
4, 5: LM guide
6: Full stud
8: Hydraulic cylinder
9: Roll cover
10: Carrier
20: Servo motor
30: Decelerator
40: Pinion
50: Rack
60: Cam follower
61: First cam follower
62: Second cam follower
70: Pivot means
80: Rotating means (Hydraulic cylinder)
90: Slide cover

### DETAILED DESCRIPTION

Hereinafter, an exemplary embodiment of the present disclosure will be described in detail with reference to the accompanying drawings.

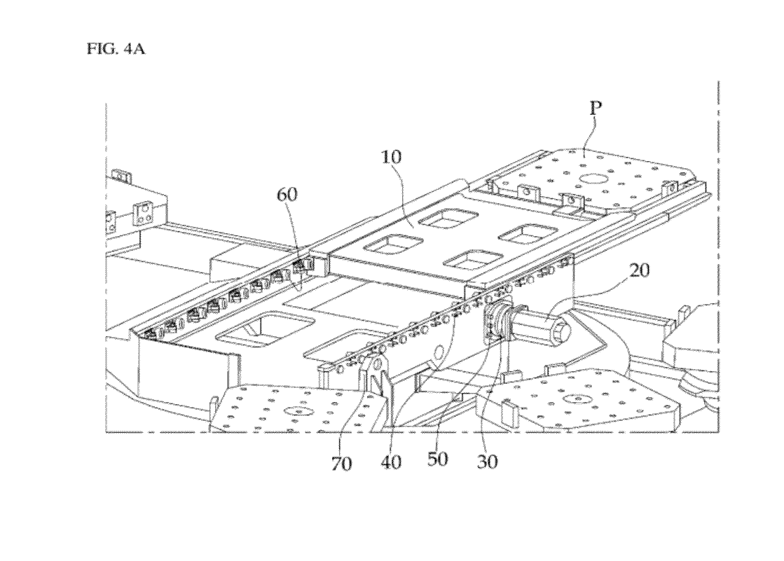

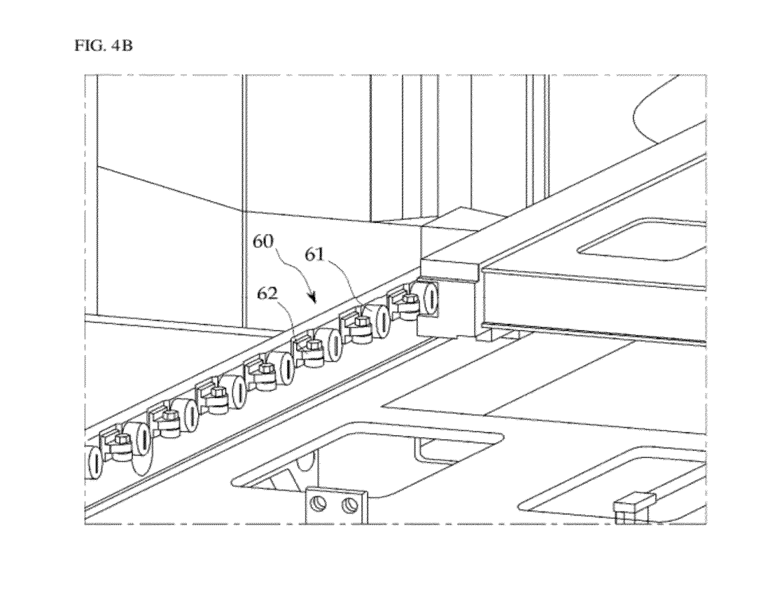

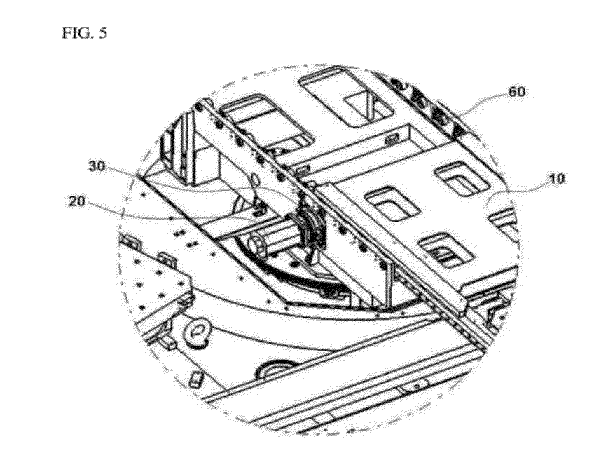

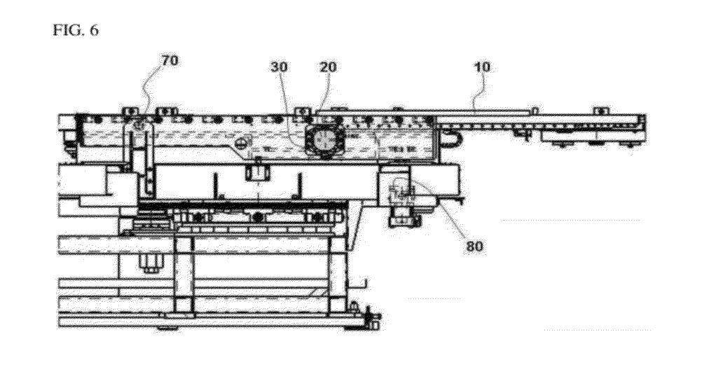

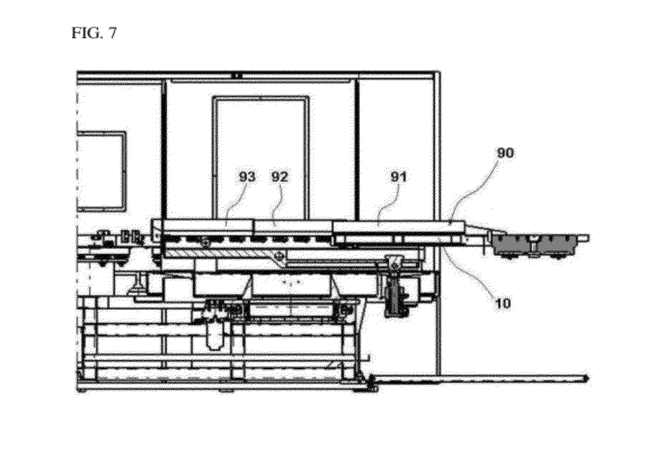

FIG. 3 is a perspective view of a pallet transferring apparatus according to the present disclosure, FIGS. 4 and 5 are detailed perspective views of the pallet transferring apparatus according to the present disclosure, and FIGS. 6 and 7 are side views of the pallet transferring apparatus according to the present disclosure.

As shown in the figures, a pallet (P) transferring apparatus of a horizontal type machine tool according to the present disclosure includes a carrier 10, a servo motor 20, a decelerator 30, a pinion 40, a rack 50, and a cam follower 60, and the pinion 40, the rack 50, and the cam follower 60 replace roles of a ball screw and an LM guide in the related art.

The carrier 10 as a means transferring a pallet P with the pallet P mounted thereon includes cam guide surfaces (not shown) on both sides, which engage with the cam follower 60 to be described below during forward and backward reciprocation transferring to guide forward and backward reciprocation transferring.

The servo motor 20 generates driving force for forward and backward transferring movement of the carrier 10.

The decelerator 30 is connected to the servo motor 20 in series to serve to decelerate rotational force received from the servo motor 20 and increase torque.

When the pinion 40 is installed on the side of the carrier 10 and receives rotational force from a predetermined power source, the pinion 40 converts the received rotational force into linear movement to enable the carrier 10 to reciprocate linearly.

The rack 50 is connected to the decelerator 30 to transfer the rotational force received from the decelerator 30 to the pinion 40. That is, the rack 50 transfers rotational movement received through the servo motor 20 and the decelerator 30 to the pinion 40 and the pinion 40 converts the received rotational movement into linear reciprocating movement and the carrier 10 coupled to the pinion 40 performs linear reciprocation transferring movement together with the pinion 40.

The cam follower 60 as a means for guiding forward and backward reciprocating transferring of the carrier 10 is fixed and disposed in plural at a predetermined interval along a forward/backward reciprocation transferring path of the carrier 10 outside both sides of the carrier 10.

Meanwhile, the center of each cam follower 60 may be concentric, but is preferably eccentric to effectively fix both the top and the bottom of the carrier 10. That is, the cam follower 60 which is eccentric slightly upward based on a center line of a reciprocation transferring path of the carrier 10 in order to fix the top of the carrier 10 and the cam follower 60 which is eccentric slightly downward based on a center line of the reciprocation transferring path of the carrier 10 in order to fix the bottom of the carrier 10 are alternately disposed, such that the cam followers 60 may be disposed in a sort of zigzag pattern.

Further, as shown in FIG. 4B, according to a more preferable exemplary embodiment, the cam follower 60 may be constituted by a first cam follower 61 and a second cam follower 62.

The first cam follower 61 is eccentric to fix both the top and the bottom of the carrier 10 and the second cam follower 62 prevents horizontal swing of the carrier 10.

Meanwhile, as shown in FIG. 6, the pallet (P) transferring apparatus of the horizontal type machine tool according to the present disclosure further includes a pivot means 70 and a rotating means (hydraulic cylinder) 80 and is configured by one fixation shaft and one rotational shaft that rotates around the pivot means 70 to receive the pallet P more simply, unlike a configuration of receiving the pallet P on two vertical and horizontal fixation shafts in the related art.

As shown in FIG. 6, the pivot means 70 is installed in the rear of a body of the carrier 10.

In addition, the rotating means (hydraulic cylinder) 80 is provided in the front of the carrier 10, such that as the rotating means (hydraulic cylinder) 80 extends, the carrier 10 may rotate around the pivot means 70.

That is, the pivot means 70 is constituted by a fixation shaft (not shown) which is a part parallel to a horizontal plane regardless of displacement of the rotating means (hydraulic cylinder) 80 in the rear part of the pivot means 70 and a rotating shaft (not shown) which is a part of which an angle formed with the fixation shaft varies by rotating around the pivot means 70 according to the displacement of the rotating means (hydraulic cylinder) 80 in the front part of the pivot means 70.

As such, the pivot means 70 is adopted, such that reception of the carrier 10 and the pallet P is configured in one rotating shaft (not shown) structure which rotates around one fixation shaft (not shown) and the pivot means 70. Therefore, the configuration is remarkably simplified as compared with the configuration of receiving the carrier 10 and the pallet P mounted thereon two horizontal and vertical fixation shafts in the related art.

Meanwhile, according to a more preferable exemplary embodiment, a slide cover 90 may be adopted in order to prevent impurities of the carrier 10 as shown in FIGS. 3 and 7. As shown in the figure, the slide cover 90 is configured in multistage, preferably in three stages, to be preferably configured in such a manner that an entire length of the slide cover 90 can extend and entire lengths of individual slide covers 91, 92, and 93 extend depending on forward and backward reciprocation transferring of the carrier 10.

The multistage slide cover 90 is remarkably better in durability and impurity infiltration prevention performance than a roll cover in the related art and effectively applicable to forward and backward reciprocation transfer of the carrier 10.

An operational principle of the pallet (P) transferring apparatus of the horizontal type machine tool according to the present disclosure will be described based on the above configuration.

First, forward and backward reciprocation transferring processes of the carrier 10 and the pallet P mounted thereon will be described.

The rotational force of the servo motor 20 is decelerated through the decelerator 30 to be converted into an appropriate rotational speed and torque. Meanwhile, the rack 50 connected to the decelerator 30 in series rotates by receiving the rotational force from the decelerator 30.

When the rack 50 rotates, while the pinion 40 fixed onto both sides of the carrier 10 engages with the rack 30, the rotational movement received from the rack 50 is converted into the linear reciprocation movement.

When the pinion 40 is reciprocatively transferred, the carrier 10 is also linearly and reciprocatively transferred together. Forward movement or backward movement of the carrier 10 is determined according to a rotational direction of the servo motor 10.

Meanwhile, when the carrier 10 is transferred forward and backward, the carrier 10 engages with the cam guide surface (not shown) formed on both sides of the carrier 10 and the cam follower 60 installed outside both sides of the carrier 10, such that the forward and backward transferring of the carrier 10 is guided by the plurality of cam followers 60. In this case, each cam follower 60 is disposed to be eccentric in the zigzag pattern to allow the cam follower 60 to be closely attached to the top and the bottom of the carrier 10 simultaneously, thereby improving forward and backward transferring stability of the carrier 10.

Meanwhile, the multistage slide cover 90 is installed in an upper part of the carrier 10, such that the length of the multistage slide cover 90 extends according to the forward and backward reciprocation transferring of the carrier 10.

Next, receiving processes of the carrier 10 and the pallet P mounted thereon will be described.

In order to receive the pallet P, the carrier 10 is transferred forward and backward by the pinion 40, the rack 50, and the cam follower 60 to place the pallet P at an appropriate position in a horizontal direction.

In this state, when the rotating means (hydraulic cylinder) 80 extends to push up the carrier 10 and the pallet P mounted thereon, the carrier 10 and the pallet P mounted thereon are transferred to a receivable position while rotating upward around the pivot means 70.

As such, according to the present disclosure, the pivot means 70 is adopted to receive the pallet P in a structure of one fixation shaft and one rotational shaft, and as a result, the structure is remarkably simplified as compared with the configuration of receiving the pallet P along two horizontal and vertical fixation shafts in the related art.

As described above, although certain exemplary embodiments of the present disclosure has bee described in detail, it is to be understood by those skilled in the art that the spirit and scope of the present disclosure are not limited to the certain exemplary embodiments, but are intended to cover various modifications and changes without departing from the gist.

Accordingly, since the above-mentioned exemplary embodiments are provided to inform those skilled in the art of the scope of the present disclosure, it should be understood that they are exemplary in all aspects and not limited and the present disclosure is just defined by the scope of the appended claims.

1. A pallet transferring apparatus of a horizontal type machine tool, comprising:
a carrier transferring a pallet and having cam guide surfaces on both sides;
a servo motor;
a decelerator decelerating rotational force received from the servo motor and increasing torque;
a pinion converting the rotational force into linear reciprocation movement of the carrier when the pinion is installed on the side of the carrier and receives the rotational force;
a rack engaging with the pinion and transferring the rotational force received from the decelerator to the pinion; and
a cam follower engaging with the cam guide surface of the carrier to guide forward and backward reciprocating transferring of the carrier.

2. The pallet transferring apparatus of a horizontal type machine tool of claim 1, further comprising:
a pivot means rotatably fixing a rotational shaft with respect to a fixation shaft parallel to a horizontal plane; and
a rotating means varying an angle between the carrier on the rotational shaft and the horizontal plane by rotating the rotational shaft around the center of the pivot means.

3. The pallet transferring apparatus of a horizontal type machine tool of claim 1, further comprising:
a slide cover for protecting the carrier from impurities according to a linear reciprocation transferring position of the carrier.

4. The pallet transferring apparatus of a horizontal type machine tool of claim 1, wherein the cam follower includes:
a first cam follower which is eccentric to fix the top and the bottom of the carrier simultaneously; and
a second cam follower for preventing horizontal swing of the carrier.
